(19) United States
(12) Patent Application Publication
(10) Pub. No.: US 2007/0299829 A1
(43) Pub. Date: Dec. 27, 2007

(54) PRICE COMPARISON ENGINE AND RELATED SEARCHING METHODS AND SYSTEMS INCLUDING MERCHANT BIDDING

(76) Inventors: Alan Neil Boinus, Laguna Beach, CA (US); James Chen, Shanghai (CN)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/764,127

(22) Filed: Jun. 15, 2007

Related U.S. Application Data
(60) Provisional application No. 60/814,265, filed on Jun. 16, 2006.
(60) Provisional application No. 60/866,209, filed on Nov. 16, 2006.

(51) Int. Cl. G06F 17/30

(52) U.S. Cl. 707/3

(57) ABSTRACT

Disclosed herein is a price search engine and method for producing up to the minute prices for queried goods and services. Also disclosed are novel advertisement systems and methods, that converge internet advertising with print and television advertising and novel enhanced merchant bidding methodologies, systems and products by such processes.

### BACKGROUND

This application claims full Paris Convention Priority of U.S. Ser. No. 60/814,265 filed Jun. 16, 2006, and Ser. No. 60/866,209 filed Nov. 16, 2006, by the first named inventor.

As use of the Internet becomes increasingly prevalent for discriminating consumers, tools aiding consumers in making purchasing decisions in making choices continue to be developed. In order for these tools to be developed, however, mechanisms must be in place that allow tool developers to benefit from the investment of time and capital into the development of the tool.

### SUMMARY

Disclosed herein is a price search engine and method for producing up to the minute prices and data extraction of prices for queried goods and services. Also disclosed are novel advertisement systems and methods, that converge internet advertising with print and television advertising.

Disclosed is a system comprising a pre-indexer, a user interface, an connection to the internet, and a database, wherein the pre-indexer analyzes a plurality of webpages based on keywords and word attributes, the analysis being used to populate the database with data, a comparer, which compares a user search query with the data in the database, the result being a set of webpages, searching the set of webpages for prices corresponding with the user search query, and returning a set of prices corresponding to the search query and a link to the webpage corresponding to each price.

Additionally disclosed in the system, is a method comprising creation of a first data set by pre-indexing keywords in a plurality of webpages by organizing the data set into a database, accepting a user query, and analyzing the user query to form a second data set by comparing the first data set and the second data set to generate a set of webpages related to the search query, and outputting the set of webpages URIs to the user.

Further disclosed is a system comprising coordinating internet advertising with television advertising, wherein internet advertisements are shown at around the same time a television advertisement is displayed.

Yet another disclosure is a method comprising the steps of determining the advertisements that will appear on television and pricing internet advertising to correspond with the airing of advertisements on television.

Disclosure of a process to comprise allowing advertisers to bid for placement of an advertisement, the advertisement being displayed based on keywords input by a user in a search wherein the bid comprises an offer to sell a product or service at a given price wherein the advertisement with the lowest bid is the advertisement displayed to users is disclosed.

Likewise, a method comprising providing a detection mechanism is disclosed that is able to detect embedded signals in printed literature interpreting the contents of an imbedded signal and linking a web browser to a webpage based on the content of the imbedded signal.

Further disclosed is a system for merchant bidding which comprises, in combination, a first entity searching for a low price for a good or service, a plurality of other entities that submit at least one bid to a server, a server to display the lowest price submitted by one of the other entities whereby a search is performed by a consumer with the intent to buy, whereby a notifier sends a notice to bidders of a bid status. The display allows the consumer to purchase at least one product for the other entity with the lowest bid, and each other entity may place a single bid for at least one term to be offered to the first entity.

### DRAWINGS

The above-mentioned features and objects of the present disclosure will become more apparent with reference to the following description taken in conjunction with the accompanying drawings wherein like reference numerals denote like elements and in which:

FIG. 1 is a flowchart of an embodiment describing the interrelationship of the present disclosure.

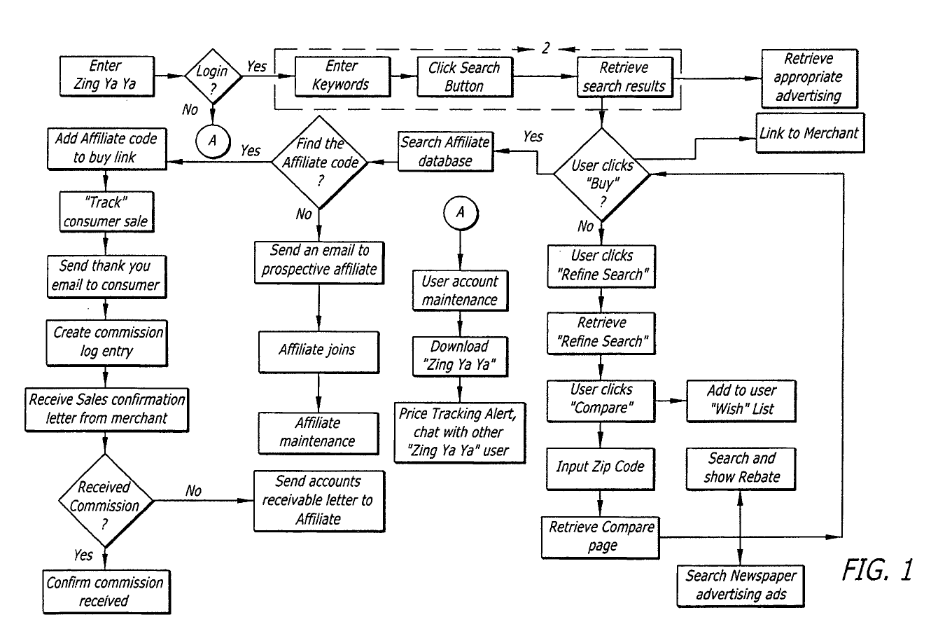

FIG. 2 is a flowchart of an embodiment of the search process.

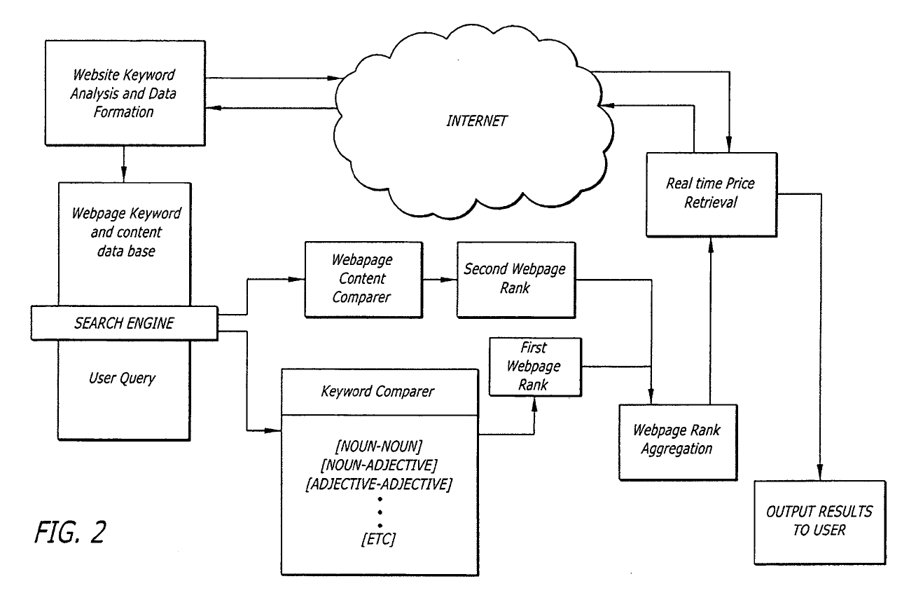

FIG. 3 is a diagram of an embodiment of signaling using signals embedded in print advertisements.

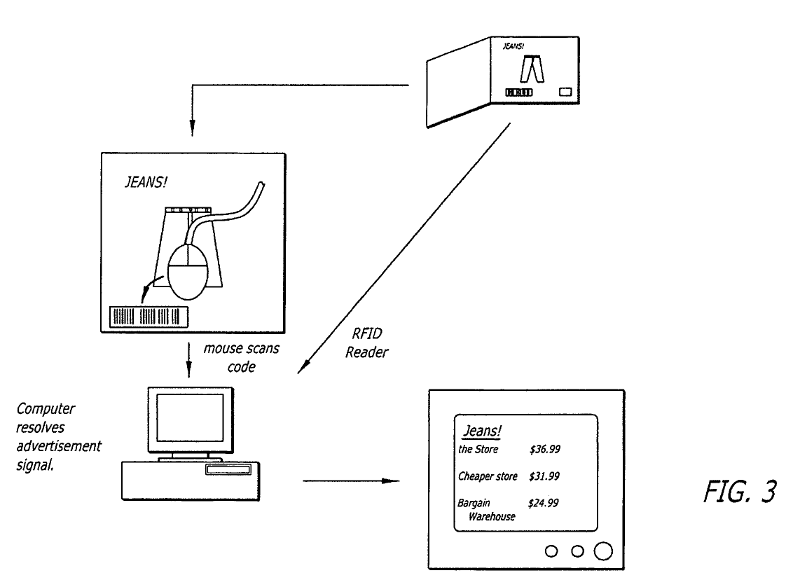

FIG. 4 schematically depicts systems and methods for merchant bidding according to the embodiments of the present disclosure.

### DETAILED DESCRIPTION

As used in the present disclosure, the term “reverse bidding” will be defined as bidding down of prices by sellers.

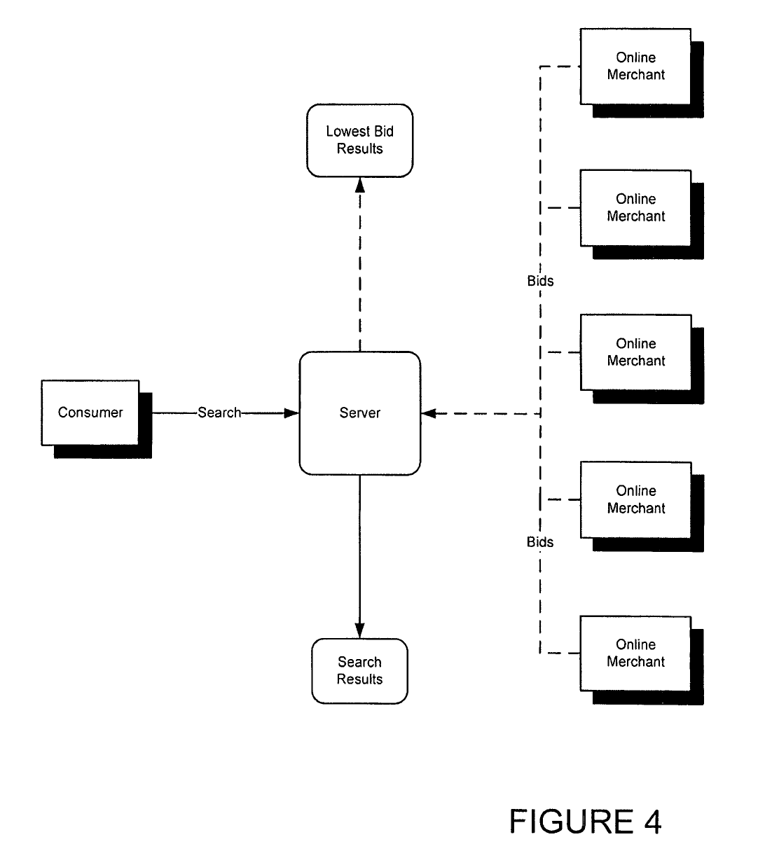

According to embodiments shown in FIG. 4, there is shown a novel searching process according to the present disclosure, wherein a consumer enters a search. As a result, the search engine returns a search result, as would be known to a person of ordinary skill in the art. During or before the time that the search results are displayed to the consumer, online merchants are permitted to “bid” a low price for the item being searched. The lowest bid is displayed as a best advertised or sponsored price to the consumer, and the advertiser pays for the advertisement. The advertisement display of the lowest bid will be seen by anybody making the same search for as long as the advertisement is displayed prior to its expiration.

Generally, only single bid corresponding to the lowest price for the good or service searched will be display with the search results. Thus, the searcher may be offered a price below the prices returned as part of the search result. According to embodiments, low bids may last for a given time period, for example one hour, a given number of times displayed, until outbid, based on a fee paid to the search engine facilitating the bid, or other ways of expiring low bids, as known in the art.

Consumers may search for general categories of items rather than specific items, according to embodiments. In these cases, low bids for various brands and models are returned with the search results. According to embodiments, multiple best advertised or sponsored low bids may be displayed with a search result. According to other embodiments, no search results will be displayed. Instead, only the low bid on a plurality of products will be displayed. Although multiple brands and models of a good or service will be returned, only a single low price corresponding to the low bid will be returned for a given model and brand.

According to embodiments, users may submit a good or service to a specialized search engine that returns only the low bid for a particular good or service and not other results. According to embodiments, the searcher may have an account and must log in prior to searching. Once the user closes the browser, logs out of the account, a specific time limit expires, or similar events occur, the low price expires. If the searcher logs in again and performs the same search, the searcher may not be offered the good at the same price. According to this embodiment, searchers will search expecting only a single result or a small handful of results corresponding the a certain number of low bids. In this way, the searcher can even correlate shipping fees into the low price to figure out the lowest overall price that will be pad for a given item. According to other embodiments, consumers will be given a reference number that may be used within a given time period to purchase the good or service at the bidded value after the fact.

In some cases, no active bids will exist on a given good or service. In other cases, the searcher will err in entering search parameters. According to embodiments, if no good or service matches the search exactly, either due to searcher error or due to the lack of active bids for the product, a suitable substitution product may be displayed as the low bid. Generally in such cases, however, the low bid product will correspond to a particular product category, brand, etc., ensuring that the substitute low bid returned is related to the original search.

According to embodiments, the bidding process occurs in real time or prior to returning a result. Artisans will know and understand how to implement a bidding process. Likewise according to embodiments, the bidding process may involve a cut off time. For example, advertisers selling Cannon EOS 20D cameras may wish to bid to have an advertisement with their low price displayed on December 20. The bidding “window,” that is the amount of time that a particular time slot for which a bid will be accepted for a given time period, for the day of December 20 may therefore have a cut-off of December 18 at midnight.

Bidding may occur in a variety of ways. According to embodiments, a bidding process may be implemented were bids are submitted using forms on a backend module of the search engine. Bidders may indicate the product to be bid upon. According to embodiments, they may enter a given product name, or according to other embodiments, select products from a hierarchy of menus to ensure consistency in the products being bid upon. Artisans will know and understand the variations in a bid placement process and may implement a variety of features and methods of placing bids based on the objective of each bidding implementation.

Bidders, according to embodiments, may bid on advertising “real estate” on a search engine results page for an exclusive product, on a result page for a more general category search, or both. Differentiating between these types of bids allows bidders to vary the prices depending on the type of search. For example, a bidder bidding on a price for a search directed to a specific product may be willing to make a lower bid to reflect the ability of the searcher to directly compare the bidders price with other merchant's prices for the same product. Conversely, searchers will not directly be able to compare prices in a category search. Consequently, the bidder may not wish to submit as low a bid in the second case.

According to embodiments, bidders may bid based on a given date and time range. The date and time range may be determined by the search engine, for example one hour time periods throughout each day, according to embodiments, allowing advertisers to price based on the time period and demand for a given product. When used in conjunction with targeted advertising, such as when a set of television commercials runs during Monday Night Football for a particular product, for example, bids based on time periods gives merchants the opportunity to anticipate demand and submit price bids accordingly.

Similarly, bidders may determine the date and time range of a given bid. Allowing bidders to determine the length of time a low bid will exist provides bidders with a degree of automation. For example, bidders may seek consumers of an ACME widget for a one week period. During the hours of 12 AM to 6 AM, bidders may not wish to bid. From 6 AM until 3 PM, bidders may bid to sell the widget at $1.50. From the hours of 3 PM until 12 AM, the bidder may wish to drop the bid price to $1.40. Throughout the one week period, the bidder need not monitor the bidding process. Rather, the bidding process will auto-bid for the bidder according to the parameters indicated. Accordingly, other useful parameters may also be used, as would be known to artisans, including bids based on the numbers of clicks, targeted advertising events, and so forth.

According to similar embodiments, the bidding window may expire immediately prior to display of the low bid. According to such an embodiment, the bidding process would be fluid and competitive as merchants may adjust bidding dynamically. Artisans will known and understand how to implement such a bidding process without undue experimentation.

Search engine may provide a backend for bidders to enter bidding parameters, such as those outlined above. The backend may provide forms, or equivalent mechanisms to submit bids.

According to similar embodiments, bidders may place bids using an XML feed, such as a syndication feed. The search engine will monitor the XML feed periodically, for example every 15 minutes. According to embodiments, the search engine may define the XML fields and default values. Consequently, bidders need simply produce and modify their XML feed according to the fields accepted by the server to modify the parameters of their bid. According to embodiments, the search engine may provide a software client to streamline or optimize the process.

As with other online auctions, it is contemplated in the present disclosure that bidders may bid a range of bids. If the bidder does not win with their high price bid, the bid will be lowered in predetermined increments until the bidder is either the low bidder or the bid reaches the low end of the bidders range. As known to artisans, and according to embodiments, notification, such as by email or instant message, may be provided to the bidder when outbid or each time the bidder's bid is lowered. If out-bid, bidders will then have the opportunity to re-bid. Artisans will know and understand how to implement the entire auction process, including the resolution of priority for bids of the same value.

According to embodiments, the bidding process may be open, that is bidders will see each other's bids and may bid accordingly. According to other embodiments, the auction will be closed and only price shown will be the low bidder's low sale price, allowing bidders to bid accordingly. These principles are well known in the art and require no further elucidation herein.

When a bidder wins and their advertisement is displayed, the bidder will pay an advertising fee, as known in the art. Such an advertising fee may be a cost per click fee, a cost per action fee, cost per acquisition fee, or flat fee, according to embodiments. The methods of charging advertisers is well known in the art and will be understood by artisans.

Advertisers may not only bid for a low price, according to embodiments, but also bid the other terms relevant to a transaction. For example, an advertiser may bid on shipping and handling terms, payment terms, such as payment over time or layaway, etc. Artisans will know and understand the terms that may be negotiated.

According to embodiments, the principles of the present disclosure may be implemented in a specific search engine wherein consumers offer to competing sellers a right to bid for the opportunity to do business with them. The specific search engine may therefore be more appealing to consumers who are ready to consummate a purchase. Consumers may indicate a product they wish to purchase and may submit a search for the product to the specific search engine. The specific search engine notifies sellers of the potential buyer for the good and sellers may bid prices to the consumer. A smaller scale auction may then be initiated for a short time period, for example 3 minutes, in which the sellers bid down the price of the good. As disclosed previously, the auction may occur in real time or through the use of prior bidding processes.

According to embodiments, the consumer may start with a general search that shows a result. On the page showing the result, the consumer may be able to click a link to use the specific search engine, wherein merchants bid for the opportunity to do business with the consumer, the bidding being by low price or other factors such as price and shipping fees, according to embodiments. Generally, the bidding transaction for the specific search engine may vary from consumer to consumer, according to embodiments. Thus, the price for all searchers may differ from consumer to consumer and from time to time.

According to embodiments, the specific search engine may provide a venue wherein the consumer may watch the bidding process. Allowing the consumer to watch the bidding process will allow the consumer to be entertained for a short period during which bidding occurs, as well as ensure to the consumer that the auction is actually occurring. Naturally, such a venue would likely work best in the context of a real-time auction, but it may also be implemented with automated bidding.

Once the auction ends, the lowest bid offer to sell is presented to the consumer. The consumer will have the option to buy, but may be limited to a given time period to decide or will lose the opportunity if the consumer closes the webpage. To prevent abuses, consumers may be limited to a set number of searches for the same product for a given time period, according to embodiments. According to other embodiments, consumers will be given a reference number that may be used within a given time period to purchase the good or service at the bidded value after the fact.

Other principles disclosed herein may apply to the specific search engine, as appropriate and according to various embodiments. Moreover, the principles of the present disclosure apply to transactions between merchants and consumers. However, according to embodiments, they may apply equally transactions between businesses.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

As defined in the present application, the term “module” shall be defined as an integral part of a core implementation or an add-in feature into a separate core implementation.

In the last decade, search engines have become ubiquitous with users. Initially, search engines were geared to help internet users search and locate webpages of interest. As search engine technology progressed, programmers started to use the generalized idea for more specific type searching. Such examples include searching for files, images, and prices from online stores.

The present disclosure is a search engine that given internet users a unique tool for searching for products and prices on the internet. Current product and price search tools are limited. First, they are index driven, which means that prices for products quoted to consumers are current only to the last time a search engine “robot” visited the merchant and collected price and product information. Thus, consumers using these search engines are not guaranteed to have current pricing information. Second, for the search engines to be profitable, they often allow merchants to have preferred status. When search results are displayed many, if not all, of the results are those of preferred merchants. Consequently, users do not benefit from an unbiased set of results showing the lowest price found on the internet from all available merchants, but only the lowest price from the preferred merchants.

The present disclosure alleviates these problems and others. The teachings of the present disclosure provides a search engine that gives real time price results. The present disclosure also provides methods of raising revenue with the use of the engine taught in the present disclosure without comprising an unbiased set of results. Because the set of results is not a reflection of the interests of merchants who have paid to have their results shown, the consumer gets the best price on the internet.

The present disclosure generally discloses a price and product comparison search engine that searches webpages on the internet. According to an embodiment, the underlying method accepts a search term and returns an unbiased, real time list of products and prices. The result set is sortable and clicking on any item will link the user to the merchant advertising the product and price.

The core search engine provides a novel enhanced tool that provides real time results. Simply, the novel engine matches the search request with the closest best price on the internet. From each webpage searched, the engine extracts the data from the applicable webpages and returns the data to user.

Prior to allowing users to enter search queries, the search engine visits the pages on the internet. The search engine, however, does not index webpages in the same manner of a typical shopping search engine, that is by visiting the pages at intervals and recording the prices for items. Rather, the key words on each webpage are analyzed and indexed. The results of the analysis and indexing are entered into a database for later use.

The user is presented with a screen designed to accept search strings. After a user enters a search string into a screen designed to accept search strings and submits them to the search engine, the search engine parses the word or phrase submitted and obtains a ranking result of webpages based on the frequency of the search strings in the pre-indexed webpages. Using word attributes, such as parts of speech, the search engine narrows the list of resultant webpages. This “drilling down” process produces a more fine-tuned ranking of webpages as the result. For example, the user enters “ACME DVD 200+” as the search string. The terms “ACME” and “200+” are modifiers of “DVD.” After the search engine obtains rankings of webpages, it uses the modifiers, such as “ACME,” and “200+” to refine, or drill down, the webpages that contain matches to the user query.

The webpage data in the database and the search query data may be compared to each other in multiple dimensions, in embodiments, to increase the strength and accuracy of the search engine. For example, the search engine may compare noun and adjectives, followed by nouns and verb, followed by adjective and verbs in succession, scoring each individual comparison and then flagging the webpages with the best general result. For example, the user inputs “ACME DVD 200+.” The search engine compares each of the following to the webpage data in the database: DVD and AMCE (noun-adjective), followed by DVD and 200+ (noun-adjective), and ACME and 200+ (adjective-adjective). Each comparison produces a result. The webpages that score the highest for the comparisons in aggregate are ranked the highest and selected for real time search.

Likewise, according to embodiments, comparisons between the query keywords and the webpage keyword data of the database may be analyzed in multiple dimensions. The first dimension is as previously described, namely, a keyword to keyword comparison and ranking of the webpages. Thereafter the keywords of the query are mapped to the page contents as a whole, which produces a correspondence score between the webpage contents and the keywords. Again, the analysis of each dimension is tallied and the webpages with the best results in aggregate are ranked the highest.

For example, a user wants the best price for an “ACME DVD 200+” DVD player. The keyword analysis comparison is completed as described above. Thereafter, the search engine looks at the context of the pages and excludes non-merchant pages. In an exemplary embodiment, the search engine might look for multiple dollar signs or a multiplicity of one of the keywords, such as “DVD” in the webpage, to exclude weblog entries that merely mention the price pad for a ACME DVD player 5 months earlier.

According to an embodiment of the present disclosure, the search engine comprises an intelligent search module. In essence, the intelligent search module enables the system to differentiate a general search from a product specific search. For example, the search engine will differentiate between a search for “DVD Player” and a search for a specific brand and model of DVD player. Similarly, an embodiment of the search engine will differentiate between a brand name search and a specific model of the brand name.

In addition to entering a search string, users may alternately select a search from a plurality of menus, each menu depending on the choice made in the prior menu. For example, the user might select “DVD Player” from a menu, after which a submenu of DVD player brands is displayed. The user would select “ACME,” which would display a menu of specific model numbers. The model number could then be chosen. At any point in the process, the user could submit the search without making selection of the next displayed submenu. Instead, or in addition to these types of choices, the user might also be able to input alternative criteria such as price ranges, features desired, and other criteria options that a user might consider as part of a purchasing decision. In embodiments, users may restrict their searches to particular countries.

After the pages are ranked, the search engine searches an arbitrary number of the highest ranked pages, starting with the highest ranked. The search is performed in real time. That is, the search engine actually visits each page, extracts price data, and returns the result to the user with a URI to the webpage. The search engine arbitrarily selects a predetermined number of pages from which to retrieve data. In one embodiment, the search engine retrieves data from a set number of webpages, such 100 webpages. In another embodiment, the search engine retrieves data from all webpages above a threshold ranking. Still other embodiments retrieve data from webpages for a set time period. Other embodiments may use combinations of the above or other similar criteria that would be known to a person of ordinary skill in the art. After the data is retrieved, the price data and URI's are returned to the user as output. Thus, the result set viewed by the user is representative of the prices listed for the desired product as of the time of the search.

According to the exemplary embodiment, the search engine may be tailored to search both the websites of merchants, for example Amazon.com, and auction sites, such as eBay. The implementation and application of the present disclosure to both merchants' websites and auction sites is known in the art. When showing auction site price, according to embodiments, the time remaining in the auction may also be displayed with the price. Indeed, in embodiments, auction listing could be sortable based on time remaining in the auction, which would allow users to choose the auction item to bid on based on the time considerations. Implementation would be understood and known to a person of ordinary skill in the art.

In addition to the engine's functionality with respect to obtaining prices for products of the search query, embodiments also contemplate revealing the presence of rebates and other special offers associated with the product of interest. When the results are revealed, rebates and special offers are displayed with the price. The combination of the price and rebates will allow embodiments of the search engine to display the reduced price, once the rebates and special offers are applied to the original price. Mail-in type rebates may be directly available and on-file with the search engine as a method of capture revenue, as discussed below. Other embodiments simply link the user with the seller's website. Users may then obtain forms for rebates and special offers directly from the merchant's website.

According to a certain embodiment, the price displayed to a consumer only reflects the price as adjusted by any applicable rebates or special offers that are available when redeemed in person. Consequently, the user will be unaware of the rebate until the page is printed. When the user prints the offer, the associated rebates or special offers will be printed for redemption with the vendor of the product or with the manufacturer of the product. Alternate embodiments immediately display the rebates and special offers to users so that the user may make informed decisions regarding purchasing preferences.

According to embodiments of the present disclosure, additional modules may provide the search engine with additional functionality. Modules specifically contemplated in embodiments include country specific targeting, tariff computation for foreign purchases, sales taxes to be paid with the purchase, “side-by-side” comparison of similar products, saving of searches, comparison of products and product features, and integration with Microsoft forms and Infotech technology. Likewise contemplated is a “wish list” feature, which allows users to select items and be alerted when the price drops or drops below a given threshold. The implementation of each of these features would be understood and known to a person of ordinary skill in the art.

The present disclosure also contemplates, in embodiments, the ability for the user to start with a general search and narrow the search down to one or more products that meet various predetermined criteria. Using these criteria, users can narrow down the available choices by inputting the criteria either prior to the search or after the search is complete. Once the desired criteria is input, the search result set is updated with products that meet the users inputted criteria.

According to embodiments, users may be undecided about their purchasing criteria. A narrowing down module may be included with the software that allows users to narrow down products according to various, disparate criteria simultaneously. For example, a user may be willing to pay $1,000 or more for a Canon SLR digital camera, but wouldn't pay over $1,000 for a Nikon SLR digital camera. Nevertheless, the user could input both criteria into the narrowing down module and obtain a set of results reflective of both sets of criteria, that is, Canon SLR digital cameras for over $1,000 and Nikon SLR digital cameras for less than $1,000.

Additionally, a filter module may be included that will allow users to omit undesired results from a search or a search result set. Like the narrow down module, the filter module allows users to further fine tune search results based on undesired criteria. For example, a user may wish to purchase a small Canon camera for less than $300. Using a combination of narrow down module and a filter module, the user may be presented with a set of search results. Thereafter, the user may decide to omit all cameras from the list that are more than a given weight. By filtering out the heavier cameras, the user is presented with a fine-tuned list of options from which to compare.

In embodiments, the present disclosure may be implemented to search classified listings apart from, or in addition to, the ability to search merchant websites and suction websites. The classified listing may be online newspaper listings or general classified websites, such as Craigslist.com. The classified search functionality will require users to input their zip code prior to searching the listings. Results will consequently be tailored to the user's own community. These results may thereafter be saved and compared to, for example, searches of merchant's websites.

According to yet another feature, a tool bar may be provided as part of a web browser. Coordinating use of the toolbar with website browsing allows users to highlight keywords in a webpage. Once highlighted, these keywords are used as the basis of a search using a search engine, for example the search engine of the present disclosure.

According to still another feature in an embodiment, the search engine is integrated into cell phones. For example, when a consumer is at a store, they may use their cell phones to access the search engine and retrieve prices for products that they are interested in purchasing at a conventional store. The webpages accessible on cell phones may be specifically designed wireless access protocol (WAP) webpages.

The present disclosure also provides a novel revenue generation model. The model is based on using the search engine to earn commissions and sell advertising space. The core advertising model presents advertisements to users when the advertisement presented is a better offer than the other offers presented on the internet. The best price offered is obtained in a bidding process, which allows advertisers to bid for the lowest price that would be offered at a particular time. Winning bids allows the advertisers' offer to be displayed for a given time period. According to embodiments, when bidding, the advertiser would bid on a time spot with a lowest price for a predetermined price per click mechanism. In alternate embodiments, advertisers would pay a commission per sale rather than a per click price. Other, similar methods of revenue generation stemming from advertising is expressly contemplated by the present disclosure as known to a person of ordinary skill in the art.

Another aspect of an embodiment of the present disclosure is tying in the online advertising to correspond with television advertising. By timing internet advertising to correspond with product advertisement campaigns on television, the value for time slots corresponding with the television advertisements is enhanced. Consequently, the cost to advertise a product corresponding with television advertisements may be adjusted to reflect the increased value of the time slot. According to embodiments, the search engine bidding module would provide advertisers with information related to the times advertisements are likely to be placed, which is available from information provided by advertising agencies, clients, media companies, advertisers, and derived from the sales of television advertising spots. In an embodiment, once the television ad is confirmed as having aired at the predicted time, the advertiser is charged a premium for the online advertising spot.

Similarly, according to an embodiment, television advertisements are tracked. Corresponding advertisements are displayed concurrently or shortly after the television advertisement to further induce potential consumers to click on and purchase the products shown on the television and internet advertisements. Similar to coordinating television ads with internet advertisements, displaying internet advertisements in response to advertisements shown on television increases the value of the internet advertising spot allowing a premium charge for the internet advertisement.

Likewise contemplated according to embodiments of the present disclosure is the compiling and categorizing of television advertisements by a television show. User searches may be recorded and advertisements may be displayed based on probable television shows that the user watches. For example, a user searches for product X and product Y. During the Prime Time television show, both product X and product Y are advertised. During subsequent searches, other products may be advertised to the use that were advertised during Prime Time. In embodiments, the user's attention may be drawn to the fact that a specific product was a sponsor of the Prime Time television show. Consequently, advertising based on temporal advertising spots provides a value added to advertisers, allowing them to target advertising based on user behavior.

According to embodiments of the present disclosure, an automated arbitrage system bids on keywords with, for example, Google or Yahoo. The bids are based on advertising fees paid by advertisers. The system disclosed bids on keywords in these search engines to maximize profitability of advertisements. This principle is especially appropriate when used in combination with the coordination of television advertising because many web sites require a minimum level of web traffic on the ads displayed. Thus, using the arbitrage system in combination with the other features of the present disclosure allows advertisers to advertise a greater range of products and have them featured prominently on another website. For example, ACME shampoo may be advertised during a television show. Using the automated arbitrage system, a set of keywords would be bid for a position as a Google sponsored link. Keywords could include not only words that identify the product, such as “ACME” or “shampoo,” but keywords identified with the television show, actors, and topics covered in the show, and other, similar products advertised during the show. Advertisements for ACME shampoo would then be more likely to generate traffic, justify placement as a Google sponsored link.

Similar to the automated arbitrage system is an automated affiliate contacting system. This system contacts a merchant and checks to see if there is an affiliate program. If so, the affiliate program is joined in order to raise additional revenue. For each transaction, an automated sales confirmation letter will be sent to the affiliate. If an affiliate program does not exist, the search engine obtains contact information for the merchant and sends out a letter inviting the merchant to pay a small commission for the direction of traffic to the website.

One of the areas in which we see considerable growth and a means to establish a niche is in the area of layaway. Instead of naming the “price” the consumer names the “deal.” We would implement a mechanism for the consumer to obtain products he/she desires without having to make an upfront expenditure of the total amount. This can be accomplished by automating a program in which PayPal or a similar escrow agent would hold consumers money eventually releasing it to merchants (and to us for commissions) when the product is paid for and shipped out.

Another module disclosed by the present disclosure combines internet advertising and sales with print advertising. According to an embodiment, print advertisers may include an embedded signaling device in their printed advertisements. Such a device could be a bar code or an RFID tag. Upon activation, the device would transmit to an appropriate reader product information. For example, a print advertisement for Levi's jeans has a bar code embedded in a corner of the advertisement. A reader, wishing to know more about the jeans and potentially purchase the jeans, runs her optical mouse over the bar code. A program embedded running in the background recognizes the signal from the mouse and causes the operating system to open a web browser and link to a search engine to locate the lowest price for the jeans or any other website that is useful for the purposes of advertising to a user or allowing the user to become better informed or purchase a product. According to the exemplary embodiment, a premium may be charged to advertisers for the search based on the increased chance of sales due to the advertisement.

According to a similar embodiment, a print advertisement may also contain a radio frequency identifier (RFID) tag. When an appropriate hardware device detects the presence of the RFID in the vicinity of the computer, websites may be signaled to advertise the product of the print advertisement. Because no volitional effort must be made by the user to signal their interest in the product of the printed page, the RFID embedded signal would have the effect of causing the advertisements in the magazine to occur more frequently online as well. Consequently, advertisers would pay a premium to have advertising generated by the presence of an RFID tag in the user's home. In an alternate embodiment, the first time an RFID tag is detected, the operating system would cause a web browser to open and link to the search engine page disclosed herein to give consumers the lowest price for the products featured in the print advertisements.

According embodiments shown in FIG. 4, there is shown a novel searching process according to the present disclosure, wherein a consumer enters a search. As a result, the search engine returns a search result, as would be known to a person of ordinary skill in the art. During or before the time that the search results are displayed to the consumer, online merchants are permitted to “bid” a low price for the item being searched. The lowest bid is displayed as a best advertised or sponsored price to the consumer, and the advertiser pays for the advertisement. The advertisement display of the lowest bid will be seen by anybody making the same search for as long as the advertisement is displayed prior to its expiration.

Generally, only single bid corresponding to the lowest price for the good or service searched will be displayed with the search results. Thus, the searcher may be offered a price below the prices returned as part of the search result. According to embodiments, low bids may last for a given time period, for example one hour, a given number of times displayed, until outbid, based on a fee paid to the search engine facilitating the bid, or other ways of expiring low bids, as known in the art.

Consumers may search for general categories of items rather than specific items, according to embodiments. In these cases, low bids for various brands and models are returned with the search results. According to embodiments, multiple best advertised or sponsored low bids may be displayed with a search result. According to other embodiments, no search results will be displayed. Instead, only the low bid on a plurality of products will be displayed. Although multiple brands and models of a good or service will be returned, only a single low price corresponding to the low bid will be returned for a given model and brand.

According to embodiments, users may submit a good or service to a specialized search engine that returns only the low bid for a particular good or service and no other results. According to embodiments, the searcher may have an account and must log in prior to searching. Once the user closes the browser, logs out of the account, a specific time limit expires, or similar events occur, the low price expires. If the searcher logs in again and performs the same search, the searcher may not be offered the good at the same price. According to this embodiment, searchers will search expecting only a single result or a small handful of results corresponding the a certain number of low bids. In this way, the searcher can even correlate shipping fees into the low price to figure out the lowest overall price that will be paid for a given item. According to other embodiments, consumers will be given a reference number that may be used within a given time period to purchase the good or service at the bidded value after the fact.

In some cases, no active bids will exist on a given good or service. In other cases, the searcher will err in entering search parameters. According to embodiments, if no good or service matches the search exactly, either due to searcher error or due to the lack of active bids for the product, a suitable substitution product may be displayed as the low bid. Generally in such cases, however, the low bid product will correspond to a particular product category, brand, etc., ensuring that the substitute low bid returned is related to the original search.

According to embodiments, the bidding process occurs in real time or prior to returning a result. Artisans will know and understand how to implement a bidding process. Likewise according to embodiments, the bidding process may involve a cut off time. For example, advertisers selling Cannon EOS 20D cameras may wish to bid to have an advertisement with their low price displayed on December 20. The bidding “window,” that is the amount of time that a particular time slot for which a bid will be accepted for a given time period, for the day of December 20 may therefore have a cut-off of December 18 at midnight.

Bidding may occur in a variety of ways. According to embodiments, a bidding process may be implemented were bids are submitted using forms on a backend module of the search engine. Bidders may indicate the product to be bid upon. According to embodiments, they may enter a given product name, or according to other embodiments, select products from a hierarchy of menus to ensure consistency in the products being bid upon. Artisans will known and understand the variations in a bid placement process and may implement a variety of features and methods of placing bids based on the objective of each bidding information.

Bidders, according to embodiments, may bid on advertising “real estate” on a search engine results page for an exclusive product, on a result page for a more general category search, or both. Differentiating between these types of bids allows bidders to vary the prices depending on the type of search. For example, a bidder bidding on a price for a search directed to a specific product may be willing to make a lower bid to reflect the ability of the searcher to directly compare the bidders price with other merchant's prices for the same product. Conversely, searchers will not directly be able to compare prices in a category search. Consequently, the bidder may not wish to submit as low a bid in the second case.

According to embodiments, bidders may bid based on a given date and time range. The date and time range may be determined by the search engine, for example one hour time periods throughout each day, according to embodiments, allowing advertisers to price based on the time period and demand for a given product. When used in conjunction with targeted advertising, such as when a set of television commercials runs during Monday Night Football for a particular product, for example, bids based on time periods gives merchants the opportunity to anticipate demand and submit price bids accordingly.

Similarly, bidders may determine the date and time range of a given bid. Allowing bidders to determine the length of time a low bid will exist provides bidders with a degree of automation. For example, bidders may seek consumers of an ACME widget for a one week period. During the hours of 12 AM to 6 AM, bidders may not wish to bid. From 6 AM until 3 PM, bidders may bid to sell the widget at $1.50. From the hours of 3 PM until 12 AM, the bidder may wish to drop the bid price to $1.40. Throughout the one week period, the bidder need not monitor the bidding process. Rather, the bidding process will auto-bid for the bidder according to the parameters indicated. Accordingly, other useful parameters may also be used, as would be known to artisans, including bids based on the numbers of clicks, targeted advertising events, and so forth.

According to similar embodiments, the bidding window may expire immediately prior to display of the low bid. According to such an embodiment, the bidding process would be fluid and competitive as merchants may adjust bidding dynamically. Artisans will known and understand how to implement such a bidding process without undue experimentation.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. An improved price comparison searching system, comprising, in combination:
a pre-indexer, a user interface, a connection to the Internet, and a database;
wherein the pre-indexer analyzes a plurality of webpages based on keywords and word attributes, the analysis being used to populate the database with data;
a comparer, which compares a user search query with the data in the database, the result being a set of webpages;
novel enhanced search tools for searching the set of webpages for prices corresponding with the user search query;
returning a set of prices corresponding to the search query and a link to the webpage corresponding to each price; and at least an optional mechanism for coordinating Internet-based advertising with at least another search engine.

2. A method comprising:
creation of a first data set by pre-indexing keywords in a plurality of webpages;
organizing the data set into a database;
accepting a user query;
analyzing the user query to form a second data set;
comparing the first data set and the second data set to generate a set of webpages related to the search query; and
outputting the set of webpages URIs to the user.

3. The method of claim 2, wherein prices corresponding with the search query is outputted to the user.

4. The method of claim 2, further comprising returning a price with each website URI to the user.

5. (canceled)

6. The method of claim 2, further comprising:
allowing advertisers to bid for placement of an advertisement, the advertisement being displayed based on keywords input by a user in a search;
wherein the bid comprises an offer to sell a product or service at a given price; and,
wherein the advertisement with the lowest bid is the advertisement displayed to users.

7. The method of claim 2, further comprising:
providing a detection mechanism that is able to detect embedded signals in printed literature;
interpreting the contents of an imbedded signal; and
linking a web browser to a webpage based on the content of the imbedded signal.

8. The method of claim 7, wherein the embedded signal is at least one of a bar code and data generated by an RFID device.

9. The method of claim 8, wherein the detection mechanism is at least one of a mouse, an RFID scanner, and functional equivalents of the same.

10. The method of claim 9, wherein the webpage allows a user to purchase the good.

11. The method of claim 9, wherein the webpage is a search engine that returns to a user prices for a product.

12. The improved price comparison system of claim 2, further comprising allowing advertisers to bid for placement of an advertisement, the advertisement being displayed based on keywords input by a user in a search;
wherein the bid comprises an offer to sell a product or service at a given price; and
wherein the advertisement with the lowest bid is the advertisement displayed to users.

13. The improved price comparison system of claim 12, further comprising providing a detection mechanism that is able to detect embedded signals in printed literature;
interpreting the contents of an imbedded signal; and
linking a web browser to a webpage based on the content of the imbedded signal.

14. The improved price comparison system of claim 13, wherein data is streamed to at least another computer.

15. The improved price comparison of claim 14, wherein the system is used in conjunction with at least one of a searching and a price comparison engine.

16. A novel enhanced system for merchant bidding which comprises, in combination:
a first entity searching for a low price for a good or service;
a plurality of other entities that submit at least one bid to a server;
a server to display the lowest price submitted by one of the other entities;
wherein the search is performed by a consumer with the intent to buy;
further comprising a notifier to notice bidders of a bid status;
wherein the display allows the consumer to purchase at least one product for the other entity with the lowest bid; and
wherein each other entity may place a single bid for at least one term to be offered to the first entity.

17. The system of claim 16, wherein the aggregate bids for the at least one term are offered to the first entity as a package.

18. The system of claim 17, wherein only a single display of the best term to the first entity is shown for a particular item.

19. The system of claim 18, further comprising at least a consumer having the intention to make a purchase.

20. The system of claim 19, wherein information regarding multiple particular items are provided simultaneously.
